(19) United States
(12) Patent Application Publication
(10) Pub. No.: US 2014/0359445 A1
(43) Pub. Date: Dec. 4, 2014

(54) Audio Management Method for a Multiple-Window Electronic Device

(71) Applicant: Shanghai PowerMo Information Tech. Co. Ltd., Shanghai (CN)

(72) Inventors: Xing Lee, Shanghai (CN); Qi Pan, Shanghai (CN); Jian-Jing Shen, Shanghai (CN); Xiong-Hui Guo, Shanghai (CN)

(73) Assignee: Shanghai PowerMo Information Tech. Co. Ltd., Shanghai (CN)

(21) Appl. No.: 14/294,201

(22) Filed: Jun. 3, 2014

(30) Foreign Application Priority Data
Jun. 3, 2013 (CN) 201310216741.9

(51) Int. Cl. G06F 3/16; G06F 3/0484

(52) U.S. Cl. CPC G06F 3/165; G06F 3/0484
USPC 715/716

(57) ABSTRACT

An audio management method and an implementation in an Android Operating System are provided for allowing an electronic device to manipulate audio control of a multiple-window system and for allowing a user to manipulate audio control of execution environments corresponding to each of the plurality of windows, such as switching to a mute mode, switching to a normal audio mode, raising volume, and/or decreasing volume, and various sound processing, etc. The multiple-window system can be implemented by a multiple-window system with a plurality of windows in a single electronic device, or can be implemented by a multiple-device system including an electronic device connecting with another remote device wherein the remote device is used as an extended window. The electronic device can maintain a plurality of execution environments, wherein each of the plurality of execution environments is corresponding to a window system. A user is allowed to manipulate audio tracks of the plurality of windows by monitoring all audio track messages generated and controlled by the plurality of execution environments.

### BACKGROUND OF THE INVENTION

1. Field of Invention

The present invention relates to an audio management method, and more particularly, to an audio management method for allowing an electronic device to manipulate audio control of a multiple-window system and for allowing a user to manipulate audio control of execution environments corresponding to each of the plurality of windows. The present invention also relates to an implementation in an Android Operating System.

2. Description of Related Art

These years, mobile devices become more and more popular. As functions of mobile devices become more and more plentiful, more requirements of audio control, message sharing, and user interactivity are necessary. For example, a user is allowed to enter a divided-window mode on a mobile device, wherein a single screen can be viewed as two virtual screens. At this time, the user would like to manipulate audio control of activities corresponding to each of the plurality of windows, such as switching to a mute mode, switching to a normal audio mode (unmute), raising volume, and/or decreasing volume, and various audio processing, etc.. Besides, the user can use one mobile device to connect to another remote device, wherein the remote device can be viewed as an extended display/audio device of the mobile device, and any application can be shared to the extend display/audio device. Current mobile device (Android-Based or iOS-Based) can merely allow applications to be displayed and manipulated in a single window. When the mobile device is developed to support a multiple-window system and is operated in a multiple-window mode, it's necessary to simultaneously run a plurality of tasks and display a plurality of windows on the screen of the mobile device (including its extended screen). In addition, it's convenient to a user to allow the user to manipulate audio control of activities corresponding to the plurality of windows, which becomes one of the important topics of this field.

### SUMMARY OF THE INVENTION

It is therefore one of the objectives of the present invention to provide an audio management method for allowing an electronic device to manipulate independent audio control of a multiple-window system and allowing a user to manipulate audio control of execution environments corresponding to each of the plurality of windows, in order to solve the above-mentioned problems in the prior art.

According to one aspect of the present invention, an audio management method for managing an electronic device that operated in a multiple-window mode is provided. The electronic device is able to run multiple tasks simultaneously so as to maintain a plurality of execution environments, wherein each execution environment is corresponding to each window. The electronic device may include: one window-to-execution-environment mapping module for respectively mapping a plurality of execution environments to a plurality of windows, one audio-track-to-execution-environment mapping module for allowing a user to manipulate audio tracks of the plurality of windows by monitoring all audio track messages of the plurality of execution environments, and one window extended audio control module for providing a specific extended audio control for each specific window of the plurality of windows in order to manage the at least one corresponding specific audio track.

By adopting the audio management method for managing an electronic device that operated in a multiple-window mode of the present invention, a user is allowed to manipulate audio control of activities corresponding to the plurality of windows, such as switching to a mute mode, switching to a normal audio mode (unmute), raising volume, and/or decreasing volume, etc., which can provide more convenience to users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing an electronic device that operated in a multiple-window mode according to an embodiment of the present invention.

FIG. 2 is a block diagram illustrating the electronic device shown in FIG. 1.

FIG. 3 is a diagram illustrating how one electronic device that operated in a multiple-window mode establish associations between a plurality of execution environments, a plurality of windows, and a plurality of specific audio tracks, which allows a user to manipulate audio control corresponding to a specific window.

FIG. 4 is a flowchart illustrating how to map a specific audio track to the specific window, and how to set the gain control of the specific audio track to be played back in the specific window based on the gain control of a system audio control and the gain control of the corresponding specific window.

FIG. 5 is a diagram showing an electronic device that operated in a multiple-window mode according to another embodiment of the present invention, wherein the electronic device is connected with a remote device that acted as an extended display/audio device, such that an application (including display and audio) can be shared from the electronic device to the remote device.

FIG. 6 is a block diagram illustrating the electronic device and the remote device shown in FIG. 5.

FIG. 7 is a diagram illustrating how one electronic device that operated in a multiple-window mode (a remote device is acted as an extended window) establish associations between a plurality of execution environments, a plurality of specific audio devices, and a plurality of specific audio tracks, which allows a user to manipulate audio control corresponding to a specific windows.

FIG. 8 is a flowchart illustrating how to map a specific audio track to the specific window when another remote device is acted as the extended window, and how to set the gain control of the specific audio track based on the gain control of a system audio control of the remote device and the gain control of the corresponding specific window.

FIG. 9 is a diagram illustrating how to map the specific audio track in an Android Operating System according to a first embodiment of the present invention.

FIG. 10 is a diagram illustrating how to map the specific audio track in an Android Operating System according to a second embodiment of the present invention.

FIG. 11 is an overall flowchart illustrating how to map the specific audio track in an Android Operating System in case that one process serves the foreground task that shows in multiple windows at one time.

FIG. 12 is a flowchart illustrating an audio management method for managing an electronic device to be operated in a multiple-window mode according to an exemplary embodiment of the present invention.

FIG. 13 is a flowchart illustrating an audio management method for managing an electronic device to be operated in a multiple-window mode according to another exemplary embodiment of the present invention.

### DESCRIPTION OF EMBODIMENTS

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

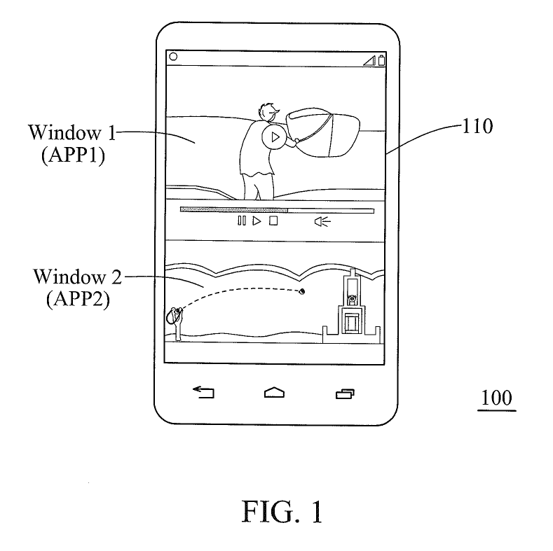

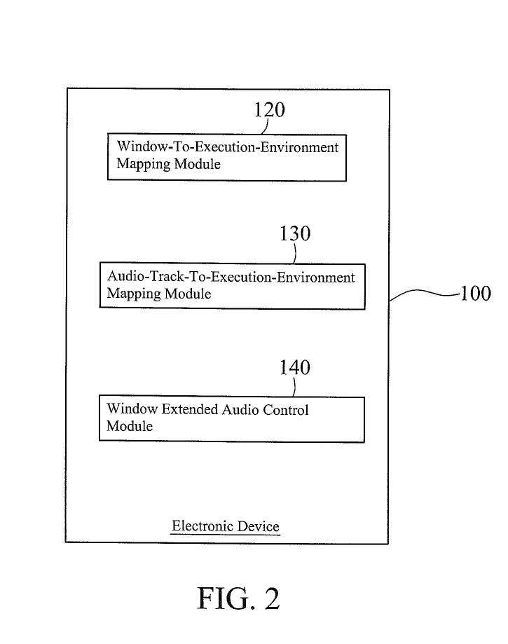

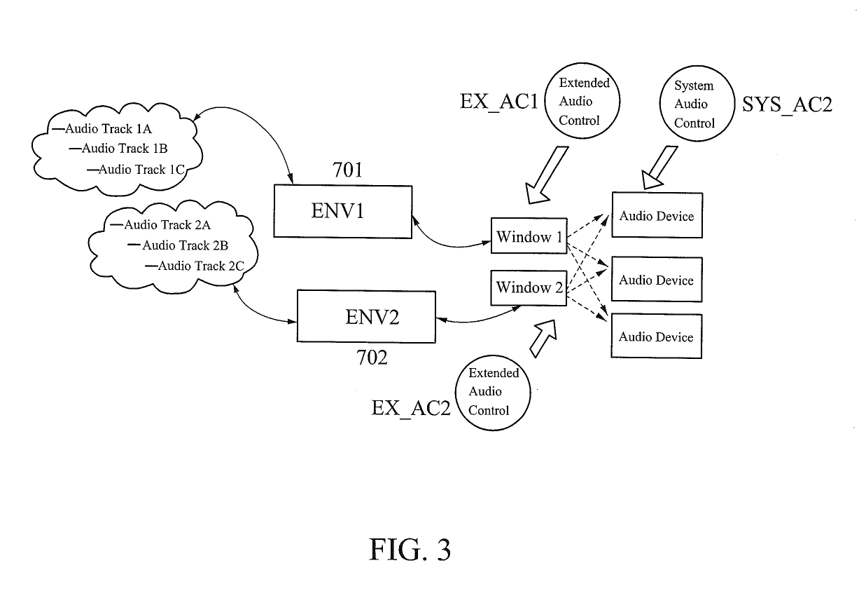

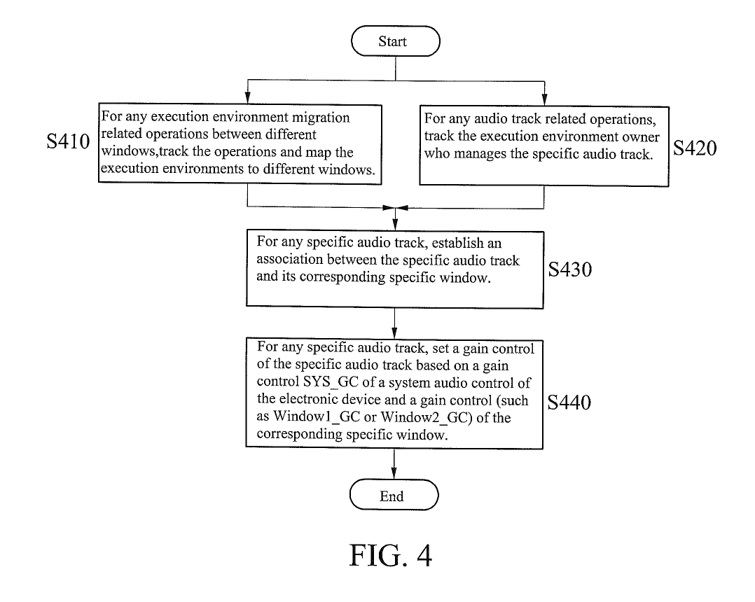

Please refer to FIG. 1 together with FIG. 2, FIG. 3, and FIG. 4. FIG. 1 is a diagram showing an electronic device 100 that operated in a multiple-window mode according to an embodiment of the present invention. FIG. 2 is a block diagram illustrating the electronic device 100 shown in FIG. 1. FIG. 3 is a diagram illustrating how one electronic device that operated in a multiple-window mode establish associations between a plurality of execution environments, a plurality of windows, and a plurality of specific audio tracks, which allows a user to manipulate audio control corresponding to a specific window. FIG. 4 is a flowchart illustrating how to map the audio track to the specific window by tracking the operation environments corresponding to each of the plurality of windows and by tracking the audio track corresponding to each of the plurality of operation environments, and how to set the gain control of the specific audio track by using the extended audio control of the specific window. As shown in FIG. 1, when the electronic device 100 is operated in a multiple-window mode, the electronic device 100 is able to simultaneously run a plurality of tasks, such as applications APP1 and APP2, wherein the plurality of tasks are corresponding to a plurality of execution environments. At this time, the plurality of windows (such as, Window1 and Window2) corresponding to the plurality of execution environments can be simultaneously or partially displayed on a screen 110 of the electronic device. As shown in FIG. 2, the electronic device 100 includes a window-to-execution-environment mapping module 120, an audio-track-to-execution-environment mapping module 130, and a window extended audio control module 140. As shown in FIG. 3, the window-to-execution-environment mapping module 120 is arranged to correspond the plurality of execution environments ENV1 and ENV2 with a plurality of windows Window1 and Window2, respectively. The audio-track-to-execution-environment mapping module 130 is arranged to establish an association between a specific audio track and its corresponding execution environment. In this embodiment, an association is established between a plurality of first specific audio tracks 1A, 1B, and IC and the first window Window1, and another association is established between a plurality of second specific audio tracks 2A, 2B, and 2C and the second window Window2. The window extended audio control module 140 is arranged to provide a specific extended audio control (such as, EX_AC1 and EX_AC2) to manage the corresponding specific audio tracks for each specific window of the plurality of windows Window1 and Window2. For example, the plurality of first specific audio tracks 1A, 1B, and 1C can be controlled via the first specific window Window1; and the plurality of second specific audio tracks 2A, 2B, and 2C can be controlled via the second specific window Window2. Since the electronic device 100 further has a system audio gain control, and thus the gain control of the specific audio track corresponding to the specific window can be represented by using the following equations:

1_{—}GC=Window1_{—}GC*SYS_{—}GC (1); and

2_{—}GC=Window2_{—}GC*SYS_{—}GC (2).

Please note that: “Window 1_GC” means the extended audio gain control of the Window1; “Window2_GC” means the extended audio gain control of the Window2; “SYS_GC” means the system audio gain control; 1_GC means the overall audio gain control of specific window Window1; and 1_GC means the overall audio gain control of the specific window Window2.

Besides volume gain control, other sound effect controls can be applied, and their processing methods are the same as the gain control.

As shown in FIG. 4, the method may include, but is not limited to, the following steps: Start.

Step S410: For any execution environment migration related operations between different windows, track the operations and map the execution environments to different windows. After that, go to Step S430.

Step S420: For any audio track related operations, track the execution environment owner who manages the specific audio track. After that, go to Step S430.

Step S430: For any specific audio track, establish an association between the specific audio track and its corresponding specific window. After that, go to Step S440.

Step S440: For any specific audio track, set a gain control of the specific audio track based on a gain control SYS_GC of a system audio control of the electronic device and a gain control (such as Window1_GC or Window2_GC) of the corresponding specific window. End.

What calls for specific attention is that: the window extended audio control module 140 is able to provide a specific extended audio control EX_AC1/EX_AC2 to manage the at least one corresponding specific audio track for each specific window Window1/Window2 of the plurality of windows. The abovementioned specific extended audio control EX_AC1/EX_AC2 may include switching to a mute mode, switching to a normal audio mode, raising volume, and/or decreasing volume; however, this should not be a limitation of the present invention. Each specific window Window1/Window2 can be viewed as an independently operating device. The user is allowed to randomly switch between different windows Window1 and Window2, and the audio strategy corresponding to the displayed window should be used for playing back the audio stream.

For example, in Android Operating System, a task or a series of related tasks can be used for describing an execution environment. During one task execution life cycle, a plurality of activities may be invoked to complete one specific task. When the user switches one current activity from a first window to a second window or shares one current activity from a first device to a second device, the execution environment corresponding to the whole task or the series of related tasks will be switched to the second window or shared to the second device.

Please keep referring to FIG. 2 and FIG. 3. In order to apply the audio control to the audio track corresponding to each of the plurality of specific windows, all specific audio tracks corresponding to the specific window should be found. After that, the window extended audio control module 140 is further arranged to manage all corresponding specific audio tracks. As shown in FIG. 3, the user can use the system audio control SYS_AC to manage the whole audio device. The specific window extended audio control EX_AC1/EX_AC2 can be used for manage the corresponding specific window. Therefore, the user is allowed to manipulate the audio control of execution environments that the windows Window1 and Window2 correspond, such as: switching to a mute mode, switching to a normal audio mode, raising volume, and/or decreasing volume, etc.

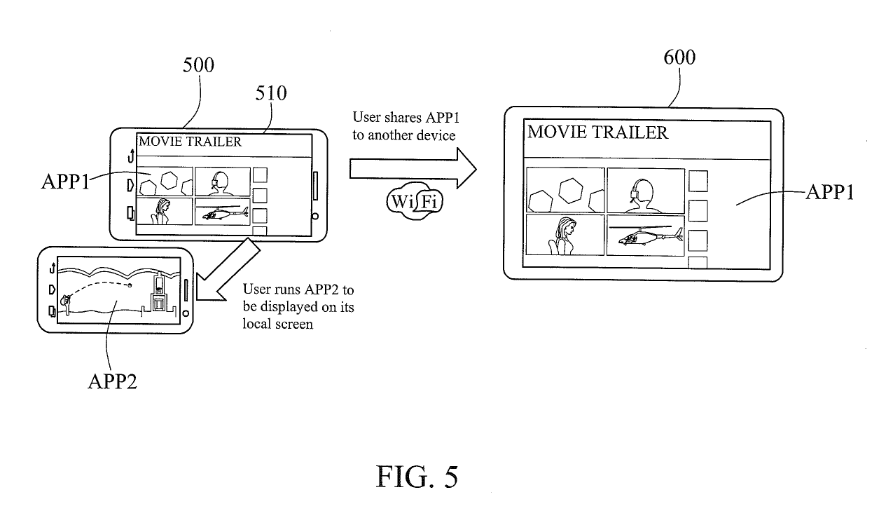

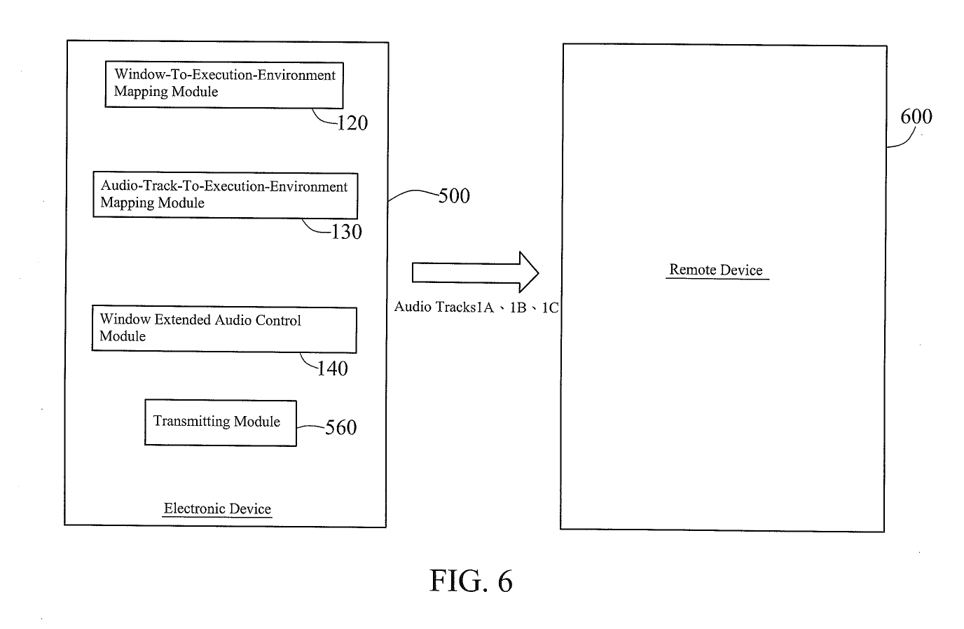

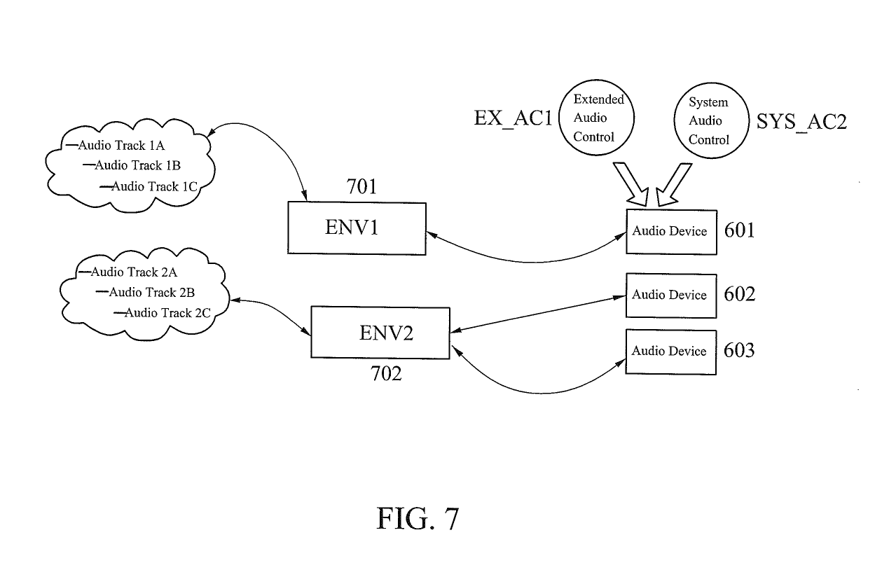

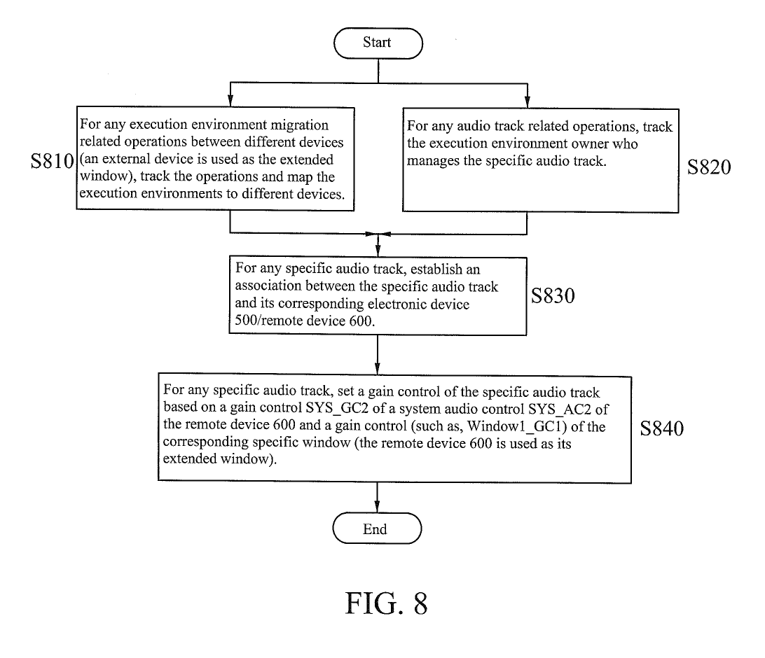

Please refer to FIG. 5, FIG. 6, FIG. 7, and FIG. 8. FIG. 5 is a diagram showing an electronic device that operated in a multiple-window mode according to another embodiment of the present invention, wherein the electronic device 500 is connected with a remote device 600, such that at least one specific audio track and the specific window can be shared from the electronic device 500 to the remote device 600. FIG. 6 is a block diagram illustrating the electronic device 500 and the remote device 600 shown in FIG. 5. FIG. 7 is a diagram illustrating how one electronic device (a remote device is acted as an extended window) establish associations between a plurality of execution environments and a plurality of specific audio tracks, which allows a user to manipulate audio control of the remote device via the extended audio control module. FIG. 8 is a flowchart illustrating how to map a specific audio track to the specific window when another remote device is acted as the extended window, and how to set the gain control of the specific audio track based on the gain control of a system audio control of the remote device and the gain control of the corresponding specific window. As shown in FIG. 5, when the electronic device 500 is operated in a multiple-window mode, the electronic device is able to run a plurality of tasks at the same time, such as applications APP1 and APP2, wherein the plurality of tasks is corresponding to a plurality of execution environments, respectively. At this time, a plurality of windows (such as, Window1 and Window2) that corresponds to the plurality of execution environments can be simultaneously or partially displayed on a screen 510 of the electronic device 500. Be noted that: the user is allowed to launch the application APP1 on the electronic device 500, and then share/transmit the application APP1 to the remote device 600, wherein such a sharing mechanism is able to map the audio, display, and user interactivity to the remote device 600. After that, the user is allowed to launch another application APP2 to be displayed on the screen 510. Please note that, the electronic device 500 and the remote device 600 are connected via a wireless display connection, and the wireless display connection may include a HDMI cable, a MHL cable, a Miracast connection, a Wi-Di connection, or a Wi-Mo connection; however, this should not be a limitation of the present invention.

Please note that, the electronic device 500 shown in FIG. 6 is similar to the electronic device 100 shown in FIG. 2, and the difference between them is that: the electronic device 500 further includes a transmitting module 560 which is arranged to transmit the at least one specific audio track (such as, a plurality of first specific audio tracks 1A, 1B, and 1C) and a specific window (such as, the specific window Window1) from the electronic device 500 to a specific remote device 600.

As shown in FIG. 8, the method includes, but is not limited to, the following steps: Start.

Step S810: For any execution environment migration related operations between different devices (an external device is used as the extended window), track the operations and map the execution environments to different devices. After that, go to Step S830.

Step S820: For any audio track related operations, track the execution environment owner who manages the specific audio track. After that, go to Step S830.

Step S830: For any specific audio track, establish an association between the specific audio track and its corresponding electronic device 500/remote device 600. After that, go to Step S840.

Step S840: For any specific audio track, set a gain control of the specific audio track based on a gain control SYS_GC2 of a system audio control SYS_AC2 of the remote device 600 and a gain control (such as, Window1_GC1) of the corresponding specific window (the remote device 600 is used as its extended window).

End.

In current Android implementation, there is no task ID associated to claim which activity should be the owner of the specific audio track, and it cannot be associated with the task. A mechanism is provided in the present invention to solve the abovementioned problem.

(Case 1) For an Android Operating System that supports a multiple-window mode, in case that one process only serves the foreground task that shown in one of the windows at one time, we can use the process ID to map the audio tracks that are created in the process. Since each process only serves one specific window at one time, the associated audio tracks can be mapped to the specific window.

(Case 2) For an Android Operating System that supports a multiple-window mode, in case that one process serves the foreground task that shown in multiple different windows at one time, we cannot use the process ID mentioned in (Case 1) to map the audio tracks with the windows. We will use Activity of Android Operating System to map the audio tracks. In Android Operating System, the audio tracks can be created in Activity or in Service, and thus the audio tracks created in Service can be viewed as triggered by a certain Activity, and different ways can be used for associating the audio tracks and Activity. Since the execution environment is based on task, the audio track can be associated with the task after the audio track is associated with Activity, and thus the audio tracks can be associated with the specific window in order to find out all the audio tracks corresponding to the specific window. Please see the following for details:

(Case 2-a) In an Android Operating System, each Activity has a fixed life (including: OnCreate, OnStart, OnResume, OnPause, OnStop, and OnDestory). During Activity's life cycle, a “Smart ID” associated with the Activity is stored in its thread local storage (TLS).

(Case 2-b) In Android Operating System, the following methods can be used for create audio tracks. In one embodiment, The Activity's Java code can be used for creating an audio track. Since the audio track is created by using the same Thread, it's easy to associate the audio track with the ID tag of the Activity. In another embodiment, different Threads can be used for creating the audio tracks. The Thread is created during Activity's life cycle. Since Thread creator will duplicate partial contents of its father

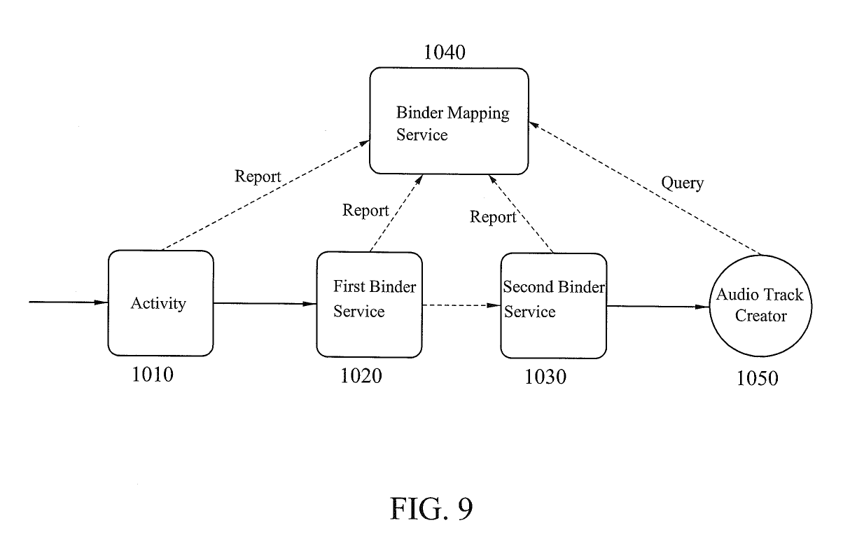

Thread, the audio tracks created by Thread can be associated with the ID tag of the Activity. In still another embodiment, audio tracks can be created by using Binder calling in an Android Operating System. Please also refer to FIG. 9. FIG. 9 is a diagram illustrating how to map the specific audio track in an Android Operating System according to a first embodiment of the present invention. In order to track the original Activity's ID tag, a Binder mapping message must be created and stored in another Global Binder Mapping Service. Through this Global Binder Mapping Service, the original Activity's ID tag can be found. As shown in FIG. 9, the Activity 1010 passes through a series of Binder Services, and finally the audio creator 1050 is used for create the audio tracks. Since each Binder calling Service is tracked by the global Binder Mapping Service, and thus the audio track creator 1050 can query Binder Mapping Service 1040 to learn that the Binder calling is initialed by the Activity 1010, and then establish an association between the ID tag of the original Activity 1010 and the audio tracks. However, the number of the abovementioned Binder callings are not a limitation of the present invention, may be one time or more than three times.

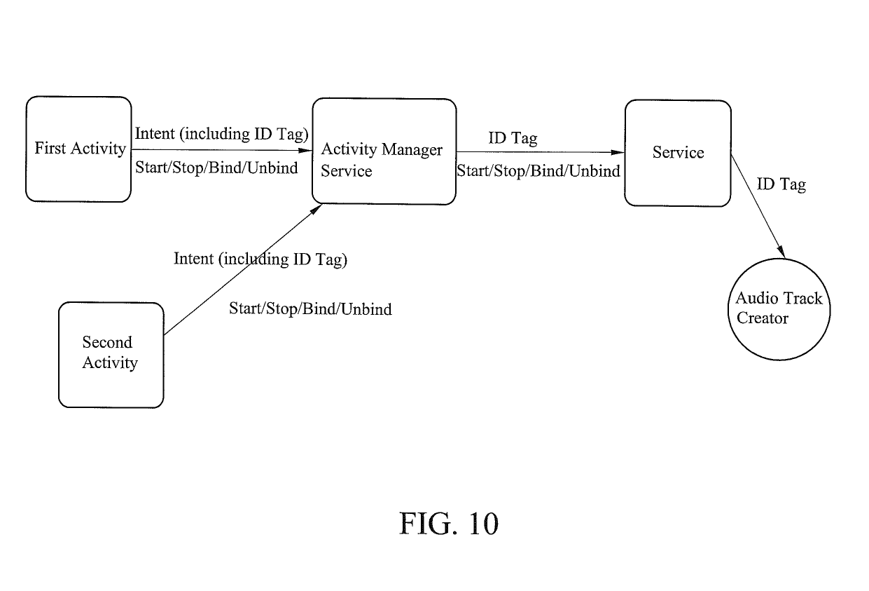

In still another embodiment, the Service can be used for creating audio tracks. Please also refer to FIG. 10. FIG. 10 is a diagram illustrating how to map the specific audio track in an Android Operating System according to a second embodiment of the present invention.

In Android Operating System, different Activities can share the same Service. In order to pass down the ID tag information to the Service, the ID tag is appended to one Intent, which is used as an association between the Activity and the Service in Android Operating System. Therefore, the Service can be notified by the Activity's ID tag that initials Service, and the audio tracks created by the Service can be associated with the ID tag.

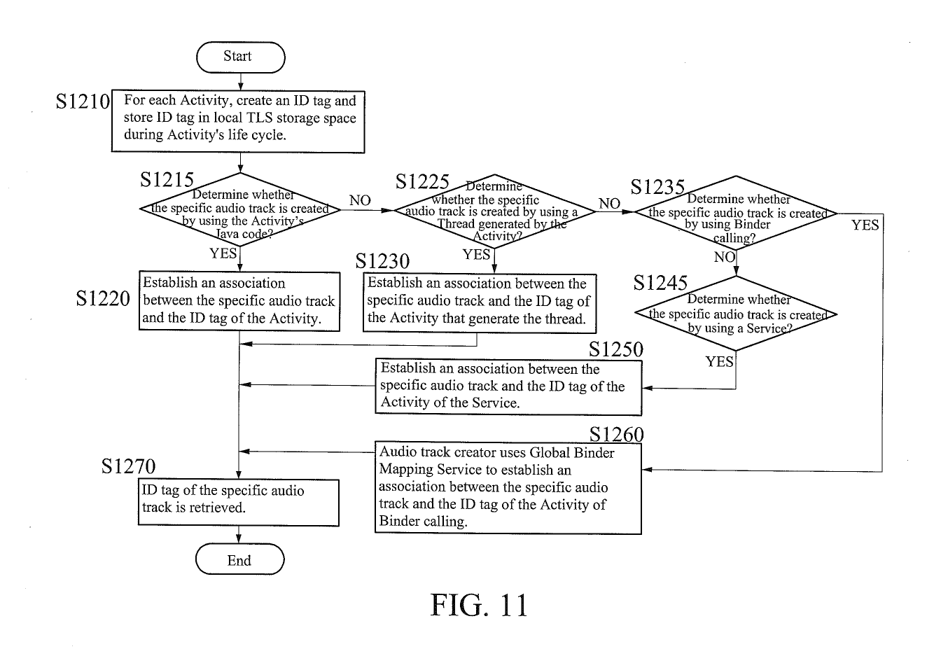

Please refer to FIG. 11. FIG. 11 is an overall flowchart illustrating how to map the specific audio track in an Android Operating System in case that one process serves the foreground task that shows in multiple windows at one time (Case 2). As shown in FIG. 11, the method includes, but is not limited to, the following steps:

Step S1210: For each Activity, create an ID tag and store ID tag in local TLS storage space during Activity's life cycle.

Step S1215: Determine whether the specific audio track is created by using the Activity's Java code? If yes, go to Step S1220; otherwise, go to Step S1225.

Step S1220: Establish an association between the specific audio track and the ID tag of the Activity. After that, go to Step S1270.

Step S1225: Determine whether the specific audio track is created by using a Thread generated by the Activity? If yes, go to Step S1230; otherwise, go to step S1235

Step S1230: Establish an association between the specific audio track and the ID tag of the Activity that generate the thread. After that, go to Step S1270.

Step S1235: Determine whether the specific audio track is created by using Binder calling? If yes, go to Step S1260; otherwise, go to step S1245.

Step S1245: Determine whether the specific audio track is created by using a Service? If yes, go to step S1250.

Step S1250: Establish an association between the specific audio track and the ID tag of the Activity of the Service. After that, go to step S1270.

Step S1260: Audio track creator uses Global Binder Mapping Service to establish an association between the specific audio track and the ID tag of the Activity of Binder calling. After that, go to Step S1270.

Step S1270: ID tag of the specific audio track is retrieved.

Those skilled in the art can readily understand how each element operates by combining the steps shown in FIG. 11 and the elements shown in FIG. 9 and FIG. 10, and further description is omitted here for brevity.

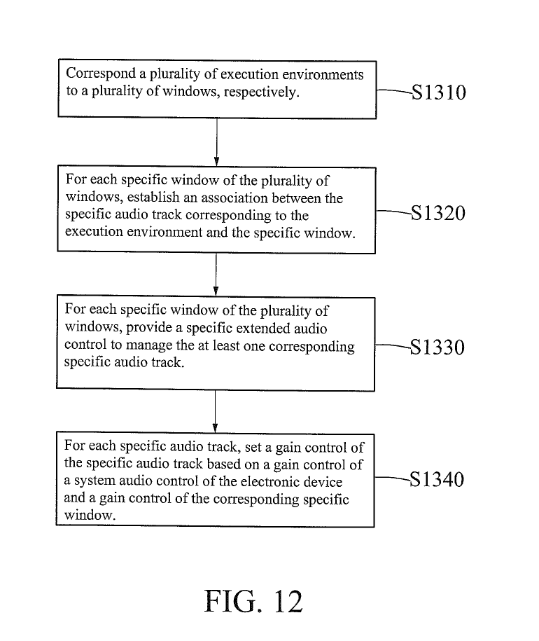

Please refer to FIG. 12. FIG. 12 is a flowchart illustrating an audio management method for managing an electronic device to be operated in a multiple-window mode according to an exemplary embodiment of the present invention. Please note that the following steps are not limited to be performed according to the exact sequence shown in FIG. 12 if a roughly identical result can be obtained. The method includes, but is not limited to, the following steps: Step S1310: Correspond a plurality of execution environments to a plurality of windows, respectively.

Step S1320: For each specific window of the plurality of windows, establish an association between the specific audio track corresponding to the execution environment and the specific window.

Step S1330: For each specific window of the plurality of windows, provide a specific extended audio control to manage the at least one corresponding specific audio track.

Step S1340: For each specific audio track, set a gain control of the specific audio track based on a gain control of a system audio control of the electronic device and a gain control of the corresponding specific window.

Those skilled in the art can readily understand how each element operates by combining the steps shown in FIG. 12 and the elements shown in FIG. 1, FIG. 2, and FIG. 3, and further description is omitted here for brevity. In one embodiment, the step S1310 is executed by the window-to-execution-environment mapping module 120; the step S1320 is executed by the audio-track-to-execution-environment mapping module 130; and the steps S1330 and S1340 are executed by the window extended audio control module 140.

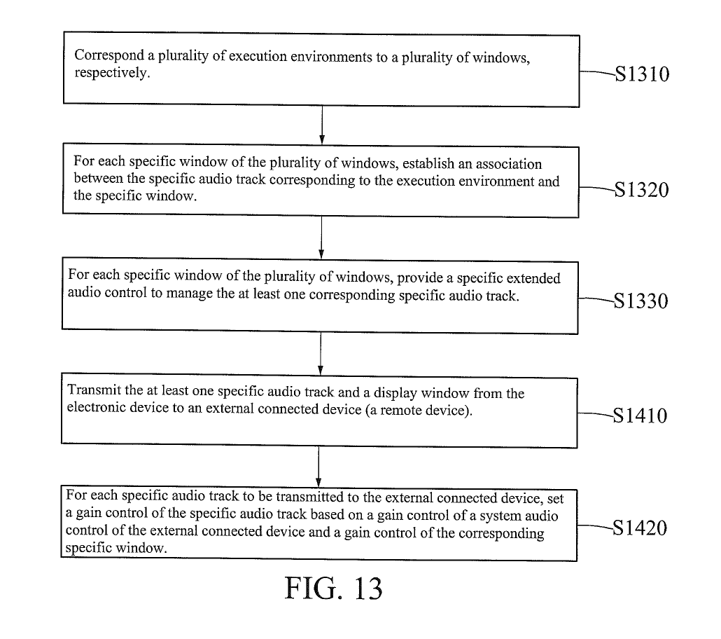

Please refer to FIG. 13. FIG. 13 is a flowchart illustrating an audio management method for managing an electronic device to be operated in a multiple-window mode according to another exemplary embodiment of the present invention. Please note that the following steps are not limited to be performed according to the exact sequence shown in FIG. 13 if a roughly identical result can be obtained. The method includes, but is not limited to, the following steps:

Step S1310: Correspond a plurality of execution environments to a plurality of windows, respectively.

Step S1320: For each specific window of the plurality of windows, establish an association between the specific audio track corresponding to the execution environment and the specific window.

Step S1330: For each specific window of the plurality of windows, provide a specific extended audio control to manage the at least one corresponding specific audio track.

Step S1410: Transmit the at least one specific audio track and a display window from the electronic device to an external connected device (a remote device).

Step S1420: For each specific audio track to be transmitted to the external connected device, set a gain control of the specific audio track based on a gain control of a system audio control of the external connected device and a gain control of the corresponding specific window.

Those skilled in the art can readily understand how each element operates by combining the steps shown in FIG. 13 and the elements shown in FIG. 5, FIG. 6, and FIG. 7, and further description is omitted here for brevity. The steps shown in FIG. 13 are similar to the steps shown in FIG. 12, and the differences between them are that: (1) FIG. 13 further includes the step S1410, wherein the step S1410 is executed by the transmitting module 560, and is used for transmitting the at least one specific audio track and the specific window from the electronic device 500 to the remote device 600; and (2) the step S1420 in FIG. 13 is used for replacing the step S1340 in FIG. 12. As shown in FIG. 12, both of the windows are displayed on the same local device (the electronic device 100); however, as shown in FIG. 13, one window is displayed on the screen of the local device (the electronic device 500) while the other window is displayed on the screen of the external connected device (the remote device 600).

The abovementioned embodiments are presented merely to illustrate practicable designs of the present invention, and should be considered to be limitations of the scope of the present invention. In summary, an audio management method for managing an electronic device that operated in a multiple-window mode and an electronic device using the same method are provided. By adopting the method and the electronic device of the present invention, the electronic device is able to simultaneously run a plurality of tasks and display a plurality of windows on the screen of the electronic device when the electronic device is operated in a multiple-window mode. Besides, it also allows a user to manipulate audio control of all activities corresponding to each of the plurality of windows, such as switching to a mute mode, switching to a normal audio mode, raising volume, and/or decreasing volume, etc., which can bring more convenience to the user.

Those skilled in the art will readily observe that numerous modifications and alterations of the device and method may be made while retaining the teachings of the invention.

What is claimed is:

1. An audio management method for managing an electronic device to be operated in a multiple-window mode, the electronic device is able to run a plurality of tasks simultaneously, and the plurality of tasks is corresponding to a plurality of execution environments, respectively, the method comprising:
corresponding the plurality of execution environments to a plurality of windows, respectively;
for each specific window of the plurality of windows, establishing an association between a specific audio track corresponding to the execution environment and the specific window; and
for each specific window of the plurality of windows, providing a specific extended audio control to manage the at least one corresponding specific audio track.

2. The method of claim 1, wherein the specific extended audio control comprises: switching to a mute mode, switching to a normal audio mode, raising volume, and/or decreasing volume, and audio processing.

3. The method of claim 1, wherein when the electronic device is operated in the multiple-window mode, the plurality of windows corresponding to the plurality of execution environments are simultaneously or partially displayed on a screen of the electronic device.

4. The method of claim 1, further comprising:
for each specific audio track, setting a gain control of the specific audio track based on a gain control of a system audio control of the electronic device and a gain control of the corresponding specific window.

5. The method of claim 1, further comprising:
transmitting the at least one specific audio track and a display window from the electronic device to a specific remote device; and
for each specific audio track to be transmitted to the specific remote device, setting a gain control of the specific audio track based on a gain control of a system audio control of the specific remote device and a gain control of the corresponding specific window.

6. The method of claim 5, wherein the electronic device and the specific remote device are connected via a wireless display connection, and the wireless display connection comprises a HDMI cable, a MHL cable, a Miracast connection, a Wi-Di connection, or a Wi-Mo connection.

7. The method of claim 1, wherein when one process of an Android Operating System only serves the foreground task that shown in a single specific window at one time, the step of for each specific window of the plurality of windows, establishing the association between the at least one specific audio track and the specific window comprises:
using a process ID to map the audio tracks that are created in the process;
wherein since each process only serves one specific window at one time, the associated audio tracks are mapped to the specific window.

8. The method of claim 1, wherein when one process of an Android Operating System serves the foreground task that shown in multiple different windows at one time, the step of for each specific window of the plurality of windows, establishing the association between the at least one specific audio track and the specific window comprises:
creating the at least one corresponding specific audio track in a Activity or a Service;
establishing an association between the at least one specific audio track and the Activity, wherein the Activity belongs to one task;
mapping the at least one specific audio track to the Activity; and
creating an ID tag, and establishing an association between the ID tag and the Activity.

9. The method of claim 8, further comprising:
determining whether the at least one specific audio track is created by using the Activity's Java code, and establishing an association between the at least one specific audio track and the ID tag of the Activity when the at least one specific audio track is created by using the Activity's Java code;
determining whether the at least one specific audio track is created by using a Thread generated by the Activity, and establishing an association between the specific audio track and the ID tag of the Activity that generate the thread when the at least one specific audio track is created by using a Thread generated by the Activity;
determining whether the at least one specific audio track is created by using Binder calling, and using Global Binder Mapping Service to establish an association between the specific audio track and the ID tag of the Activity of Binder calling when the at least one specific audio track is created by using Binder calling; and
determining whether the at least one specific audio track is created by using a Service, and establishing an association between the specific audio track and the ID tag of the Activity of the Service when the at least one specific audio track is created by using a Service.

10. An electronic device operated in a multiple-window mode, the electronic device is able to run a plurality of tasks simultaneously, and the plurality of tasks is corresponding to a plurality of execution environments, respectively, the electronic device comprising:
a window-to-execution-environment mapping module, arranged to correspond the plurality of execution environments to a plurality of windows, respectively;
an audio-track-to-execution-environment mapping module, arranged to establish an association between a specific audio track and its corresponding execution environment for each specific window of the plurality of windows; and
a window extended audio control module, arranged to provide a specific extended audio control to manage the at least one corresponding specific audio track for each specific window of the plurality of windows.

11. The electronic device of claim 10, wherein the specific extended audio control comprises: switching to a mute mode, switching to a normal audio mode, raising volume, and/or decreasing volume, and audio processing.

12. The electronic device of claim 10, wherein the electronic device further comprises a screen; and p1 when the electronic device is operated in the multiple-window mode, the plurality of windows corresponding to the plurality of execution environments are simultaneously or partially displayed on the screen of the electronic device.

13. The electronic device of claim 10, further comprising:
a gain control setting module, arranged to set a gain control of the specific audio track based on a gain control of a system audio control of the electronic device and a gain control of the corresponding specific window for each specific audio track.

14. The electronic device of claim 10, further comprising:
a transmitting module, arranged to transmit the at least one specific audio track and a specific window from the electronic device to a specific remote device; and
a gain control setting module, arranged to set a gain control of the specific audio track based on a gain control of a system audio control of the specific remote device and a gain control of the corresponding specific window for each specific audio track to be transmitted to the specific remote device.

15. The electronic device of claim 14, wherein the electronic device and the specific remote device are connected via a wireless display connection, and the wireless display connection comprises a HDMI cable, a MHL cable, a Miracast connection, a Wi-Di connection, or a Wi-Mo connection.

16. The electronic device of claim 10, wherein when one process of an Android Operating System only serves the foreground task that shown in a single specific window at one time, the audio-to-execution-environment mapping module is used for:
using a process ID to map the audio tracks that are created in the process;
wherein since each process only serves one specific window at one time, the associated audio tracks are mapped to the specific window.

17. The electronic device of claim 10, wherein when one process of an Android Operating System serves the foreground task that shown in multiple different windows at one time, the audio-to-execution-environment mapping module is used for:
creating the at least one corresponding specific audio track in a Activity or a Service;
establishing an association between the at least one specific audio track and the Activity, wherein the Activity belongs to one task;
mapping the at least one specific audio track to the Activity; and
creating an ID tag, and establishing an association between the ID tag and the Activity.

18. The electronic device of claim 17, wherein the audio-to-execution-environment mapping module is further used for:
determining whether the at least one specific audio track is created by using the Activity's Java code, and establishing an association between the at least one specific audio track and the ID tag of the Activity when the at least one specific audio track is created by using the Activity's Java code;
determining whether the at least one specific audio track is created by using a Thread generated by the Activity, and establishing an association between the specific audio track and the ID tag of the Activity that generate the thread when the at least one specific audio track is created by using a Thread generated by the Activity;
determining whether the at least one specific audio track is created by using Binder calling, and using Global Binder Mapping Service to establish an association between the specific audio track and the ID tag of the Activity of Binder calling when the at least one specific audio track is created by using Binder calling; and
determining whether the at least one specific audio track is created by using a Service, and establishing an association between the specific audio track and the ID tag of the Activity of the Service when the at least one specific audio track is created by using a Service.
